(19) United States
(12) Patent Application Publication
(10) Pub. No.: US 2020/0111069 A1
(43) Pub. Date: Apr. 9, 2020

(54) METHOD, APPARATUS, AND SYSTEM FOR PROVIDING A CREATIVE OVER A NETWORK

(71) Applicant: Gurbaksh Singh CHAHAL, Miami, FL (US)

(72) Inventor: Gurbaksh Singh CHAHAL, Miami, FL (US)

(21) Appl. No.: 16/150,730

(22) Filed: Oct. 3, 2018

(51) Int. Cl. G06Q 20/08; G06Q 20/12; G06Q 30/02; G06Q 30/08

(52) U.S. Cl. CPC G06Q 20/0855; G06Q 30/08; G06Q 30/0277; G06Q 20/123

(57) ABSTRACT

A device, method and system are disclosed for providing a creative within a third-party content slot without navigating a user away from a third-party content document in which the creative was provided for a consumption of a media item associated with the creative. As a result of at least a request for a user device to display the third-party content document, the creative is provided to the user device, the creative being displayable within the third-party content slot, and the creative including a first interface, the first interface associated with an actionable object. As a result of at least a user action taken on the actionable object to consume the media item associated with the creative, a second interface is provided to the user device for consuming the media item without navigating the user away from the third-party content document.

### TECHNICAL FIELD

The present invention relates to devices, methods and systems for providing creatives within a third-party content slot, and more specifically, providing creatives within the third-party content slot without navigating the user away from a third-party content document in which the creative was provided for the consumption of the media item associated with the creative.

### BACKGROUND

In a computer network environment, such as the Internet, content is provided by content providers, as well as, third-parties, such as, e.g., advertisers. The content may be provided in documents accessible over a network, such as, for example, a website or other software application. Such third-parties may sometimes provide content in the form of a creative within these documents and the creative may be presented alongside the primary content provided in these documents. The creative may be considered a form of electronic advertisement.

Traditional electronic advertising creatives may present information to an end-user/content viewer that invites a level of further engagement by the user. Typically, if the user engages with a creative, additional engagement is often possible only after navigation to another website or application, separate from the original website or application. Because such navigation removes the user from the original document, the user may be discouraged from further engagement with the creative in order to avoid being navigated to another website or application.

Media items are often the subject of creatives. Media items typically have a life cycle that determines the form of distribution and the timing of the access to the media and/or the subject of the media item. Separate advertising creatives may be used for each form of media distribution and for the different times of access. For example, one creative may be for advertising a song pre-release with a further level of engagement of the creative being a preview of the song. At a later date, a second creative may be used for a post-release campaign, with a further level of engagement of the second creative being a purchase of the song as a single, resulting in, for example, a download, or other access rights to the song. At yet a later date, there may be a third creative advertising an album in which the song is included, with a further level of engagement being purchase of the album or a preview of the album. At yet a later date, a fourth creative may be used to promote a tour associated with the album, where a further level of engagement may be to purchase the tickets for a concert. Similarly, a movie may have a life cycle, which life cycle may include, for example, pre-release, release to movie theaters, release to in-flight entertainment, then release to physical media (e.g., DVD, etc.), followed by a release to streaming media providers (e.g., iTunes, Netflix, Hulu, etc.). Each release may be promoted with a particular creative, different from the other releases' creatives. Accordingly, it may be difficult to determine which users may be responsive to one creative corresponding to one time period during a product life cycle and which users may be responsive to other creatives corresponding to other time periods in the product life cycle.

### SUMMARY

The present disclosure provides, in some embodiments, a method, apparatus, and system for providing an interactive creative, and, in particular, a multi-level user-targeted creative.

According to one aspect of the present disclosure, a computing device is provided for providing a creative within a third-party content slot without navigating a user away from a third-party content document in which the creative was provided for a consumption of a media item associated with the creative. The computing device includes processing circuitry configured to, as a result of at least a request for a user device to display the third-party content document, provide the creative to the user device, the creative being displayable within the third-party content slot, and the creative including a first interface, the first interface associated with an actionable object. The processing circuitry is further configured to, as a result of at least a user action taken on the actionable object to consume the media item associated with the creative, provide a second interface to the user device for consuming the media item without navigating the user away from the third-party content document.

According to this aspect, in some embodiment, the processing circuitry is configured to provide the second interface to the user device for consuming the media item without navigating the user away from the third-party content document by communicating a request to at least one content delivery server to send the media item to the user device to consume the media item at the third-party content document. In some embodiments of this aspect, the processing circuitry is further configured to provide the second interface to the user device for consuming the media item within the third-party content slot within which the creative was displayed, without navigating the user away from the third-party content document. In some embodiments of this aspect, the third-party content slot is defined at least by an Hypertext Markup Language (HTML) code associated with the third-party content document, the HTML code including at least an address indicating a location of the computing device for providing the creative for the third-party content slot, and the computing device is different from a server of primary content of the third-party content document. In some embodiments of this aspect, the processing circuitry is further configured to identify a life cycle of the media item and provide the creative to the user device by selecting the creative from a set of creatives based at least in part on the identified life cycle of the media item. In some embodiments of this aspect, the processing circuitry is configured to provide the creative to the user device by being further configured to: receive social media data associated with the user from a social media platform; based on the social media data, determine a predicted degree of interest in content associated with the media item; and select at least one offer from a set of available offers for the media item based at least in part on the predicted degree of interest, an indication of the selected at least one offer being displayable in the first interface of the creative. In some embodiments of this aspect, the processing circuitry is configured to provide the creative to the user device by being further configured to: obtain a fan attribute associated with the user from a user profile database, the fan attribute including at least a fan ranking of the user for a content attribute associated with the media item; and select at least one offer from a set of available offers for the media item based at least in part on the fan ranking of the user for the content attribute of the media item. In some embodiments of this aspect, the processing circuitry is configured to provide the creative to the user device by being further configured to determine the fan ranking of the user for the content attribute of the media item by at least identifying whether the user at least one of likes or follows at least one of an artist associated with the media item or a social media page for the media item. In some embodiments of this aspect, the first interface is configured for a first level of user engagement corresponding to at least one offer for consumption of the media item and the second interface is configured for a second level of user engagement corresponding to the consumption of the media item as a result of an acceptance of the at least one offer for consumption. In some embodiments of this aspect, the computing device includes at least one server in communication with at least a social media platform and at least one content delivery server for providing the creative to the user device over a network, the creative associated with the media item from the at least one content delivery server and the creative selected from a set of creatives available for the media item based at least in part on user information from the social media platform. In some embodiments of this aspect, the actionable object is a link to the second interface. In some embodiments of this aspect, the third-party content slot is configured for insertion of content from at least one server that is a third-party server with respect to a publishing server of primary content of the third-party content document. In some embodiments of this aspect, the third-party content document is a web page displayable by a web browser of the user device. In some embodiments of this aspect, the processing circuitry is configured to provide the second interface to the user device for consuming the media item without navigating the user away from the third-party content document by being further configured to redirect the user device to at least one content delivery server for delivery of the media item without navigating the user away from the third-party content document. In some embodiments of this aspect, the processing circuitry is configured to provide the creative to the user device by being further configured to select the creative for insertion with the third-party slot via a real-time bidding (RTB) network ecosystem, the RTB network ecosystem being configured to provide for both the selection and display of the selected creative in real-time.

According to another aspect, a method is provided for providing a creative within a third-party content slot without navigating a user away from a third-party content document in which the creative was provided for a consumption of a media item associated with the creative. The method includes, as a result of at least a request for a user device to display the third-party content document, providing the creative to the user device, the creative being displayable within the third-party content slot, and the creative including a first interface, the first interface associated with an actionable object; and, as a result of at least a user action taken on the actionable object to consume the media item associated with the creative, providing a second interface to the user device for consuming the media item without navigating the user away from the third-party content document.

According to this aspect, in some embodiments, providing the second interface to the user device for consuming the media item without navigating the user away from the third-party content document further includes providing the second interface to the user device for consuming the media item within the third-party content slot within which the creative was displayed, without navigating the user away from the third-party content document. In some embodiments of this aspect, providing the creative to the user device includes at least identifying a life cycle of the media item and providing the creative to the user device by selecting the creative from a set of creatives based at least in part on the identified life cycle of the media item. In some embodiments of this aspect, providing the creative to the user device includes receiving social media data associated with the user from a social media platform; based on the social media data, determining a predicted degree of interest in content associated with the media item; and selecting at least one offer from a set of available offers for the media item based at least in part on the predicted degree of interest, an indication of the selected at least one offer being displayable in the first interface of the creative.

According to yet another aspect of the disclosure, a system is disclosed for providing a creative within a third-party content slot without navigating a user away from a third-party content document in which the creative was provided for a consumption of a media item associated with the creative. The system includes processing circuitry and at least one database in communication with the processing circuitry and at least one social media platform. The processing circuitry is configured to: as a result of at least a request for a user device to display the third-party content document, provide the creative to the user device, the creative being displayable within the third-party content slot, and the creative including a first interface, the first interface associated with an actionable object, and as a result of at least a user action taken on the actionable object to consume the media item associated with the creative, provide a second interface to the user device for consuming the media item without navigating the user away from the third-party content document by communicating a request to at least one content delivery server to send the media item to the user device to consume the media item at the third-party content document. The at least one database is configured to store a plurality of user profiles, the plurality of user profiles including fan attributes, and receive user data from the at least one social media platform, the fan attributes determined based on the user data from the at least one social media platform.

### BRIEF DESCRIPTION OF THE DRAWINGS

FIG. 1 is a block diagram of an exemplary network architecture according to one embodiment of the present disclosure;

FIG. 2 is a block diagram of another exemplary network architecture and exemplary server according to one embodiment of the present disclosure;

FIG. 3 is a flowchart of an exemplary method according to one embodiment of the present disclosure;

FIG. 4 is a flow diagram illustrating an exemplary method of serving a creative to a user device according to one embodiment of the present disclosure;

FIG. 5 illustrates an example flow of user interface views corresponding to an example creative offering a music media item for consumption according to one embodiment of the present disclosure;

FIG. 6 illustrates an example flow of user interface views corresponding to an example creative offering a movie media item for consumption according to one embodiment of the present disclosure; and

FIG. 7 illustrates an example flow of user interface views corresponding to an example creative offering an event associated with a media item for consumption according to one embodiment of the present disclosure.

### DETAILED DESCRIPTION

Before describing in detail exemplary embodiments, it is noted that the embodiments reside primarily in combinations of apparatus components and processing steps related generating a method, apparatus, and system for providing a creative over a network. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments described herein, the term “interface” may indicate a user interface that allows a user to be presented (e.g., displayed, audio) with information via a computing device and may also include elements that allow the user to interact with the computing device by for example inputting data (e.g., input fields). In some embodiments, one or more interfaces may be part of a creative. In some embodiments, the term “creative” may be used to indicate a computer-presentable advertisement that may be provided to such computer over a network. In some embodiments, the term “creative” is intended to indicate an interactive creative (as opposed to a static advertisement such as a banner).

In some embodiments described herein, the terms “consume” and “consuming” may be used to indicate the user consuming (e.g., listening to, watching, receiving, etc.) at least a portion of the media item being advertised by the creative.

Note further, that functions described herein as being performed by a computing device may be distributed over a plurality of computing devices. In other words, it is contemplated that the functions of the computing device described herein are not limited to performance by a single physical device and, in fact, can be distributed among several physical devices. Further, it is contemplated that the functions and methods described herein are not limited to performance by a single set of computer instructions on a single physical device and, in fact, can be distributed among several sets of computing instructions (e.g., software application) on several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments of the present disclosure include a novel way to provide a creative that integrates social media platform data to select users and/or devices to target for delivery of the creative. Some embodiments of the present disclosure may also use a social media profile associated with a user to customize the creative to the particular user. In some embodiments, such customization may be selected in real-time responsive to the user's engagement with the creative. In some embodiments of the present disclosure, such customization may include analyzing the social media data/profile associated with the user. Based on the social media data (e.g., likes, follows, etc.), a level of interest the user has in the subject of the media item and/or a likelihood that the user would pay a premium to be granted access to the media item in a particular form of access at a specific time (e.g., pre-release) is determined. A creative and/or a price point is selected from a set of creatives and/or a set of price points for an offer associated with the creative. Accordingly, some embodiments include providing a social context creative that integrates social media information into the provision of the creative to a particular user.

Some embodiments of the present disclosure include providing a multi-level/multi-interface creative in which a first interface is associated with an actionable object, and a second interface is for consuming the media item without automatically navigating the user away from the document that the user is currently at. The second interface may be provided responsive to a user taking action on the actionable object. Accordingly, consumption of the media item by the user may advantageously be provided via the creative, without requiring the user to leave the website that the user is currently visiting.

In some embodiments of the present disclosure, both a product life cycle of the media item and fan data associated with the user are identified and used to determine which second interface is provided to such user. For example, one of a set of creatives may be used for a particular product life cycle (e.g., pre-release) and, based on the user's fan data from the user's social media platform a dynamic offer may be presented to the user within the creative. As a further example, there may be different pricing profiles for each life cycle of the media item and for each level of fan. For example, it may be assumed that super fans are willing to pay a substantial premium for access to a media item pre-release, therefore a price offered to the superman may be higher than other prices or, in some embodiments, only super fans are offered access to the media item pre-release. Some embodiments of the present disclosure may increase the efficiency of an ad server by being configured to only offer certain creatives to particular user pools, such as, fans or super fans. In some embodiments, the user is required to sign-in through his/her social media account in order to be presented with the second interface for consumption. By requiring the user to sign-in through the social media account, the ad server may obtain the user's social media data and/or profile (via, e.g., an application programming interface (API) associated with the social media platform). In some embodiments, such social media data may be used to select a creative and/or a target price for the media item. In some embodiments, the social media profile may be tied to other user network activity via a unique identifier within a user profile database. The social media profile may be tied to the unique identifier deterministically and/or probabilistically in order to gather even more insight into the user's interests and attributes.

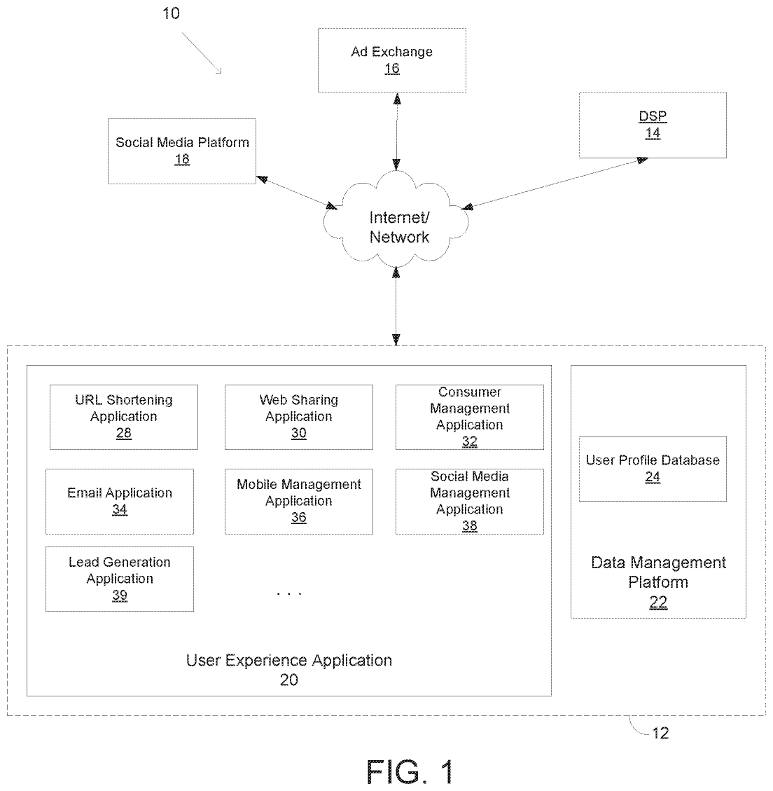

Referring now to the drawings, in which like reference designators refer to like elements, there is shown in FIG. 1 an exemplary network architecture, generally designated as “10”. The exemplary network can include a management platform 12, a demand side platform 14, an advertisement exchange 16, and a social media platform 18, communicatively coupled to one another over a network, in communication with one another, via one or more communication links, paths, connections, and/or networks (e.g., the Internet, intranet, ad hoc networks, etc.) using one or more communication protocols (e.g. Hypertext Transfer Protocol (HTTP) and other network protocols), where at least one or more elements of the management platform 12 may be configured to perform one or more of the methods and techniques described herein. Although the system 10 depicted in FIG. 1 includes a single management platform 12, a single demand side platform 14, a single advertisement exchange 16, and a single social media platform 18, it is contemplated that the system 10 may include any number of management platforms 12, demand side platforms (“DSPs”) 14, advertisement exchanges (“ad exchanges”) 16, and social media platforms 18, that may be in communication over one or more networks.

The management platform 12 may be configured to manage user experiences from a multitude of users over the network. In one embodiment, the management platform 12 may be considered a vertically integrated brand management platform. In other embodiments, the management platform 12 may be other types of user experience platforms involved in the management of user experiences and activities over the network.

In one embodiment, the management platform 12 may include a plurality of user experience applications 20, where the number of user experience applications 20 within the management platform 12 can be any number. The user experience applications 20 may be configured to create and otherwise manage content to be distributed to users across a plurality of platforms.

The management platform 12 may also include a data management platform 22 for collecting, storing, and searching data collected by the user experience applications 20. The data management platform 22 may include a user profile database 24 for storing the data collected. In some embodiments, the user experiences applications 20 can also include applications for the collection and cultivation of data regarding users and content. The exemplary user experience applications 20 depicted in FIG. 1 include a URL shortening application 28, web sharing application 30, consumer management application 32, email application 34, mobile management application 36, social media management application 38, and lead generation application 39. In one embodiment, these applications 28, 30, 32. 34, 36, 38, and 39 may work together to manage various aspect of network user experiences and may be used to collect data for use with embodiments of the present disclosure to provide a creative over a network. In other words, it is contemplated that different applications can be used to collect data, and embodiments for the data collection are not limited solely to those depicted and described herein.

The ad exchange 16 may be considered an exchange platform that enables advertisers and publishers of digital content to buy and sell digital advertising space, often through a real-time bidding (RTB) ecosystem. Generally, when a user initially accesses a document, such as, for example, a website, the website will have spaces, which may be considered third-party content slots, which can be filled with digital advertising inventory (e.g., creatives). A publisher/content provider, such as an owner of the website, may sell those spaces to the ad exchange 16. The ad exchange 16 can fill those spaces by selling the space to advertisers. As multiple advertisers may be interested in supplying creatives to the individual user at varying prices, the ad exchange 16 utilizes an RTB ecosystem whereby the advertisers may bid on the placement of their creatives based on a profile of the user that the ad exchange 16 may provide to the advertisers. RTB should generally occur within a fraction of a second. The advertiser may pay the ad exchange 16 to distribute the creative, and a portion of the payment to the ad exchange 16 may be passed onto the website owner in exchange for allowing the creative to be displayed within the third-party content slot provided by the website owner's website. Different ad exchanges 16 may have access to different pools of users and prices. Thus, advertisers may distribute their creatives across a plurality of ad exchanges 16 to access different pools of users.

The DSP 14 is a system configured to allow advertisers to manage and bid on impressions associated with digital advertising inventory from one or more ad exchanges 16 using a unified interface.

The social media platform 18 is a platform for users to engage in social media communication, such as posting user-provided content, text-based communication exchange between social media users, following other social media accounts, liking content, and the like.

Continuing to refer to FIG. 1, an embodiment of each of the plurality of the user experience applications 20 (28, 30, 32, 34, 36, 38, 39) that may collect and cultivate data for use by, for example, an advertisement server (“ad server”) will now be described. Stated another way, the user experience applications 20 may interact with network users to provide user content data that can be analyzed and used to provide a targeted interactive creative to a user according to one or more of the techniques described herein.

The URL shortening application 28 may be a Universal Resource Locator (URL) shortening and custom URL generation application, such as, for example, TRIM by Gravity4, Inc. URL shortening application 28 may be configured to provide a URL shortening service or custom URL creation for users. URL shortening application 28 may be configured to receive a link to a networked content and produce a shortened link to a first website that may redirect to the networked content. The shortened link can also be of any length, though a user-friendly form is preferred. In some embodiments, the first website may be considered a “vanity site” that is created specifically for the link. In other embodiments, the link is to a second site that may be considered a “deep link.” In this manner, the user's experience can be managed for linked content. In one embodiment, URL shortening application 28 can detect and log when and where a user clicks the shortened link and may be able to track when and where a shortened link is shared online. URL shortening application 28 may be configured to compile and present data connected to the shortened links. In some embodiments, URL shortening application 28 may be configured to assign each user that experiences (e.g., interacts with, or views) the content a unique identifier. Such unique identifier, as well as other tracking data can be stored in database and/or used by the data management platform 22. In some embodiments, the unique identifier can be used by the management platform 12 to associate a plurality of instances of user activity with particular users to create unique user profiles for such users.

Web sharing application 30 may provide and monitor intelligent web sharing, such as the application ADDNOW by Gravity4, Inc. Web sharing application 30 may be configured to determine what key words, content, hashtags, and the like become popular (e.g., go viral) by analyzing data across the network, such as, the Internet. In some embodiments, web sharing application 30 can track link sharing behavior in the social media platforms 18, social channels considered “dark social,” and other social digital communities on the network. “Dark social” includes social channels that are difficult to detect and track, such as, for example, messaging and email communications. In some embodiments, web sharing application 30 can store the content connected to links that are shared between users. In such embodiments, web sharing application 30 provides a web-based “copy-paste” function where users can share content, not just a link to content hosted elsewhere. In addition to storing the content, web sharing application 30 may further track usage data related to when and where the content is shared. In some embodiments of web sharing application 30, users that receive or shared content are assigned a unique identifier. The identifier and other data associated with such users' online activity, as well as, content received and shared between such users can be stored in the user profile database 24. In some embodiments, web sharing application 30 can be a widget, a set of computer instructions, a plug-in, or the like that can generate a link and/or icon for users to share content, which content may be trackable by web sharing application 30 and, in embodiments, associated with specific users and their unique identifiers.

Consumer management application 32 may provide services associated with the acquisition and management of consumers, such as the application CRM.ME by Gravity4, Inc. In some embodiments, consumer management application 32 can provide template messages to send to potential consumers. Consumer management application 32 can also provide a form on a website whereby users can input their contact information. Thus, the form may allow users to join message lists or express an interest in a product or service. Consumer management application 32 may then record and store data that the users have submitted via the form, or other user interface. In some embodiments, consumer management application 32 can have predefined triggers that can commence certain marketing events or campaigns. For example, when a user visits a web page, consumer management application 32 may be configured to send an email communication based on a preconfigured template. Consumer management application 32 may provide, for example, for back-end users, a visualization of collected data.

Consumer management application 32 can also manage consumer or user information for support personnel, such as, sales personnel. In some embodiments, “gamification” concepts may be used to measure and report key performance indicators. For example, when a sales person achieves a goal, application 32 can be configured to present such sales person with a reward. In some embodiments, consumer management application 32 can create comparison performance metrics for each sales person. The performance metrics can thus provide sales personnel with an indication of their level of performance, as compared to their associates, thereby fostering a sense of competition. In some embodiments, these performance metrics are summary data or sales statistics. The performance metrics can also include non-monetary statistics, such as, for example, how many phone calls the sales person made during a certain time period.

In some embodiments, consumer management application 32 can manage leads which might later convert into consumers. Such leads can be managed separately or in combination with the user profile database 24. Consumer management application 32 may be configured to maintain a dynamic queue of leads and contacts, presenting a sales person with leads and consumers that may be optimal for the sales person to contact. Consumer management application 32 can track the relations between customers and salespeople. For example, consumer management application 32 can record that a customer spoke with a first sales person on the phone and a second sales person in-person. Consumer management application 32 can set triggers and route customers based on the customer's tracked actions. Consumer management application 32 can create an organization of teams of sales people. Consumer management application 32 can establish and enforce geographical sales territories. Consumer management application 32 can be configured to create custom fields in a customer entry interface. In some embodiments, consumer management application 32 can actually call customers directly instead of requiring the sales person to manually obtain the customer's contact information and physically dialing the phone.

Consumer management application 32 can also manage tasks and sub-tasks. Consumer management application 32 can record user activities related to such tasks and sub-tasks. User activities may include, for example, meetings, emails, messages, file transfers, etc. In some embodiments, customers/users may be assigned a unique identifier. The identifiers, data related to the customer/user's interactions with sales people, and other interaction data associated with the consumer management application 32 can be stored in the user profile database 24.

Email application 34 may be configured to present an interface to creating marketing emails, such as the application DELIVER.ME by Gravity4, Inc. The interface can be configured as, for example, a “drag and drop” interface and/or may provide pre-configured templates to facilitate efficient email creation. In some embodiments, email application 34 can track user interaction data, such as, for example, message opened, message forwarded, unsubscribed, etc. In some embodiments, email application 34 can be considered a widget or plug-in that can be inserted into a website or platform. In some embodiments, users receiving marketing emails, via the email application 34, may be assigned a unique identifier. Such unique identifiers and other data associated with the email application 34 may be collected and stored in the user profile database 24.

Mobile management application 36 can collect and present user interaction data, such as user interactions/experiences with mobile applications (“apps”), such as the application UNIFY.ME by Gravity4, Inc. In some embodiments, mobile management application 36 can monitor, for example, downloads, time spent interacting with the app, time spent with the app opened on the mobile device, page visits, push notifications sent, push notifications opened, and other user interaction/experience data. Mobile management application 36 can, for example, group users into segments based on information, such as, for example, event occurrences, geo-location data, proximity to other devices, etc. For example, mobile management application 36 can group users who interact with a specific push notification and that also appear to reside in a certain geographic area, or are close to a connected smart-watch. In some embodiments, mobile management application 36 may send push notifications in response to a predetermined event trigger. For example, responsive to mobile management application 36 detecting that a user has visited a predetermined page, mobile management application 36 may send a push notification to the user. In some embodiments, mobile management application 36 may be configured to monitor user activities on the mobile devices. In some embodiments, such users may be assigned a unique identifier. Such identifiers and the interaction/experience data collected by mobile management application 36 may be stored in the user profile database 24.

Social media management application 38 can be a unified social media platform, such as the application REACH.ME by Gravity4, Inc. In some embodiments, social media management application 36 can be used to post on multiple social media platforms 18, simultaneously. For example, a user may create content on social media management application 36 and then instruct social media management application 36 to simultaneously push the user-created content on various social media platforms 18. In some embodiments, the publication is performed on a predetermined scheduled or delayed basis. The publication may also be performed by social media management application 36 as a result of predetermined triggers (e.g., user-created triggers, anniversaries, birthdays, etc.). Social media management application 36 may be configured to monitor and record data associated with the published user-created content. Such data may include, for example, conversations, clicks, interactions, reach, messaging between users, etc. Such data can also be grouped and analyzed based on, for example, an audience segment. Social media management application 36 can allow multiple users to access a singular profile on social media management application 36. These multiple users can have varying levels of permission related to the profile of an account associated with the social media management application 36. For example, some users may be able to publish content, while some users may be authorized to send messages. In some embodiments, social media management application 36 can collect data from a social media profile associated with individuals from the social media platform 18. In some embodiments, social media management application 36 may associate such data with a unique identifier associated with a user and more store the data and the identifier in the user profile database 24. In some embodiments, user data from the social media management application 36 can be used to select a creative to be served to the user. In some embodiments, user data from the social media management application 36 can be analyzed to determine various attributes of the user, such as, for example, whether the user is a fan and/or superman of the subject/content of a media item advertised by a creative. Techniques associated with this will be described in more detail below.

Lead generation application 39 may be an automated lead generation platform, such as CROSSGRAPH by Gravity4, Inc. In some embodiments, lead generation application 39 may utilize data received from the other user experience applications 20, such as, for example, consumer management application 32 and email application 34, to generate contacts that may lead to a sale or other favorable outcomes. In some embodiments, lead generation application 39 can generate leads from a user's existing cluster of customers to perform retargeting or to create similar audience segments that could potentially convert at similar rates. In other embodiments, lead generation application 39 can track and analyze conversion rates for each generation lead. In other embodiments, lead generation application 39 may be configured to provide visualization on, for example, a computer display, of the tracked and analyzed conversion rates for each generated lead to users of lead generation application 39.

It should be understood that the set of user experience applications 20 associated with the management platform 12 may include more or less than the application described herein above, which are exemplary applications. Collectively, the user experience applications 20 may provide a wide scope of coverage for reaching and tracking users over the network in a variety of digital environments. The collected data can be stored in the user profile database 24 and/or used by the data management platform 22 to perform various functions, such as, for example, providing a creative to a user within a third-party content slot according to some embodiments of the present disclosure, which will be discussed in more detail below.

Generally, while each application may have its own unique identifier for each user, such identifiers can be resolved to a global user identifier for a specific user in the data management platform 22. Stated another way, each user may be associated with an identifier for each application; but, each of such identifiers may be linked to the global user identifier for the user within the data management platform 22 so that all the data collected across the applications 20 can be associated or linked to the specific user. The user identifier may be an alphanumeric code, text, or other any type of user identifier. In one embodiment, the user identifier may be a key in a relational database corresponding to the user profile database 24. In one embodiment, the user identifier (“ID”) in the user profile database 24 is associated with a multitude of information associated with the user, such as, for example, one or more Internet Protocol (IP) addresses, one or more geo-locations for the user, a hashed email address, any combination of these, and a hashed phone number, one or more social network user ID(s) (e.g., from a pixel such as a transparent pixel on, for example, an authentication page).

Generally, data from the user experience applications 20 interacting with users over the network and the data from these interactions can be accessed by a computing device such as, for example, an ad server to identify users for targeting an advertisement campaign and, in some embodiments, for delivering a multi-interface interactive creative according to techniques described herein. Based on the identification of these users, advertisers can use the DSP 14 to bid on the ad exchange 16 to be able to advertise to these identified users. Data from social media platforms 18 associated with the users can also be used to provide a particular creative to a particular user to provide a social context creative.

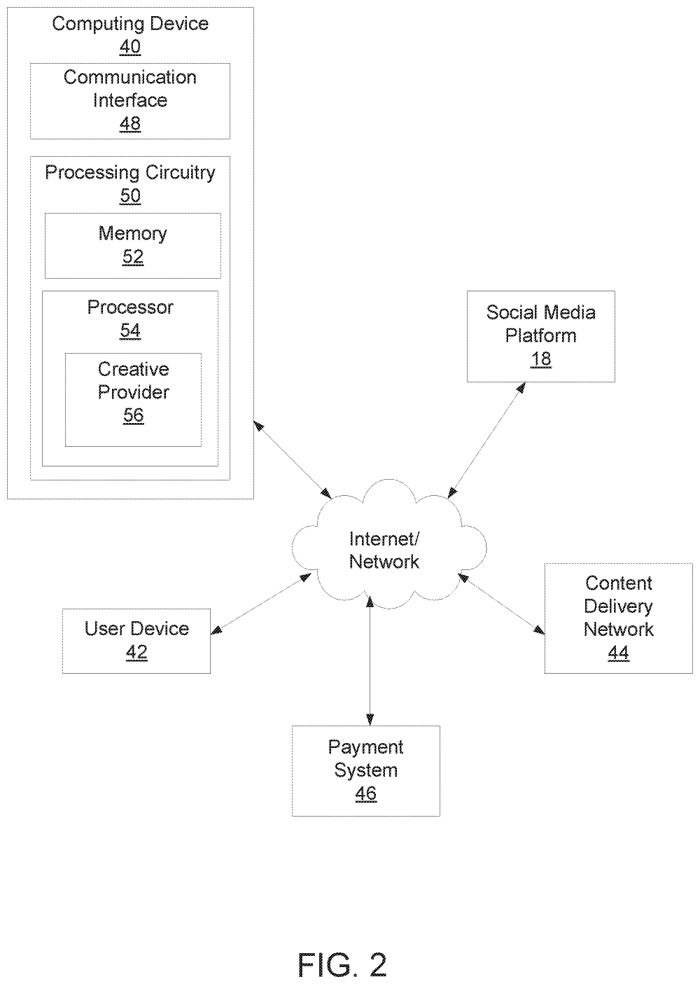

Having described each element of the network architecture of the system 10 shown in FIG. 1, some embodiments of the present disclosure will now be described with reference to the block diagram of FIG. 2. FIG. 2 illustrates yet another network architecture with an exemplary computing device 40 that may be used to implement at least some of the embodiments of the present disclosure. The network architecture may further the social media platform 18, as well as, at least one user device 42, content delivery network 44, and payment system 46 connected over a network, such as the Internet.

The computing device 40 may include hardware and/or may run software configured to implement one or more of the techniques and methods described herein for providing a creative according to the disclosure. For example, in one embodiment, the computing device 40 may be configured to access the user profile database 24 described with reference to FIG. 1 for selecting a creative to deliver to a user based on e.g., social media profile data. In some embodiments, the user profile database 24 may be stored in memory within the computing device 40. In other embodiments, the user profile database 24 may separate from and in communication with the computing device 40. In some embodiments, the computing device 40 may be an ad server or other provider of advertising creatives. It is contemplated that, in some embodiments, one or more of the user experience applications 20 and/or parts or all of data management platform 22 may also be implemented by and/or included in the computing device 40. In other embodiments, one or more of the user experience applications 20 may be run on computing devices separate from but in communication with the computing device 40. The one or more user experience applications 20 and/or data management platform 22 and/or parts thereof may be implemented across multiple computing devices 40 and/or distributed in a cloud computing environment. In such cases, is it contemplated that these separate computing devices can have the same general computing architecture, i.e., hardware arrangement, as the computing device 40.

In some embodiments, the computing device 40 includes a communication interface 48, processing circuitry 50, and memory 52. The communication interface 48 may be configured to communicate with other networked devices and elements in the system 10 (e.g., the management platform 12, the demand side platform 14, the ad exchange 16, the social media platform 18, content delivery network 44, user device 42, payment system 46, etc.). In some embodiments, the communication interface 48 may be formed as or may include, for example, one or more radio frequency (RF) transmitters, one or more RF receivers, and/or one or more RF transceivers, and/or may be considered a radio interface. In some embodiments, the communication interface 48 may include a wired and/or a wireless interface. In one embodiment, the communication interface 48 may include or be associated with a network interface element, such as, for example, network interface card.

The processing circuitry 50 may include one or more processors 54 and memory, such as, the memory 52. In particular, in addition to a traditional processor and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 54 and/or the processing circuitry 50 may be configured to access (e.g., write to and/or read from) the memory 52, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the computing device 40 may further include software stored internally in, for example, memory 52, or stored in external memory (e.g., database) accessible by the computing device 40 via an external connection. The software may be executable by the processing circuitry 50. The processing circuitry 50 and/or a creative provider 56 may be configured to control any of the methods and/or processes described herein and/or to cause such methods, and/or processes to be performed, e.g., by the computing device 40. The memory 52 is configured to store data, programmatic software code and/or other information described herein. In some embodiments, the software may include instructions that, when executed by the processor 54 and/or the creative provider 56, causes the processor 54 and/or the creative provider 56 to perform the processes described herein with respect to the computing device 40. In particular, the instructions stored in the memory 52 may be instructions for implementing the methods and techniques described herein for providing a creative to a user device 42.

The computing device 40 may be considered a computing device implementing the creative provider 56 for providing a creative within a third-party content slot without navigating a user away from a third-party content document in which the creative was provided for a consumption of a media item associated with the creative. The processing circuitry 50 may include and/or may implement the creative provider 56. The processing circuitry 50 may be configured to, as a result of at least a request for a user device 42 to display the third-party content document, provide the creative to the user device 42, the creative being displayable within the third-party content slot, and the creative including a first interface, the first interface associated with an actionable object. The processing circuitry 50 may be further configured to, as a result of at least a user action taken on the actionable object to consume the media item associated with the creative, provide a second interface to the user device 42 for consuming the media item without navigating the user away from the third-party content document.

According to this aspect of the computing device 40, in some embodiments, the processing circuitry 50 is configured to provide the second interface to the user device 42 for consuming the media item without navigating the user away from the third-party content document by communicating a request to at least one content delivery server to send the media item to the user device 42 to consume the media item at the third-party content document. In some embodiments, the processing circuitry 50 is further configured to provide the second interface to the user device 42 for consuming the media item within the third-party content slot within which the creative was displayed, without navigating the user away from the third-party content document. In some embodiments, the third-party content slot is defined at least by an Hypertext Markup Language (HTML) code associated with the third-party content document, the HTML code including at least an address indicating a location of the computing device 40 for providing the creative for the third-party content slot, and the computing device 40 is different from a server of primary content of the third-party content document. In some embodiments, the processing circuitry 50 is further configured to identify a life cycle of the media item and provide the creative to the user device 42 by selecting the creative from a set of creatives based at least in part on the identified life cycle of the media item. In some embodiments, the processing circuitry 50 is configured to provide the creative to the user device 42 by being further configured to: receive social media data associated with the user from a social media platform 18; based on the social media data, determine a predicted degree of interest in content associated with the media item; and select at least one offer from a set of available offers for the media item based at least in part on the predicted degree of interest, an indication of the selected at least one offer being displayable in the first interface of the creative. In some embodiments, the processing circuitry 50 is configured to provide the creative to the user device 42 by being further configured to: obtain a fan attribute associated with the user from a user profile database 24, the fan attribute including at least a fan ranking of the user for a content attribute associated with the media item; and select at least one offer from a set of available offers for the media item based at least in part on the fan ranking of the user for the content attribute of the media item. In some embodiments, the processing circuitry 50 is configured to provide the creative to the user device 42 by being further configured to: determine the fan ranking of the user for the content attribute of the media item by at least identifying whether the user at least one of likes or follows at least one of an artist associated with the media item or a social media page for the media item. In some embodiments, first interface is configured for a first level of user engagement corresponding to at least one offer for consumption of the media item and the second interface is configured for a second level of user engagement corresponding to the consumption of the media item as a result of an acceptance of the at least one offer for consumption. In some embodiments, the computing device 49 is a server in communication with at least a social media platform 18 and at least one content delivery server 44 for providing the creative to the user device 42 over a network, the creative associated with the media item from the at least one content delivery server 44 and the creative selected from a set of creatives available for the media item based at least in part on user information from the social media platform 18. In some embodiments, the actionable object is a link to the second interface. In some embodiments, the third-party content slot is configured for insertion of content from at least one server that is a third-party server with respect to a publishing server of primary content of the third-party content document. In some embodiments, the third-party content document is a web page displayable by a web browser of the user device 42. In some embodiments, the processing circuitry 50 is configured to provide the second interface to the user device 42 for consuming the media item without navigating the user away from the third-party content document by being further configured to redirect the user device 42 to at least one content delivery server 44 for delivery of the media item without navigating the user away from the third-party content document. In some embodiments, the processing circuitry 50 is configured to provide the creative to the user device 42 by being further configured to select the creative for insertion with the third-party slot via a real-time bidding (RTB) network ecosystem, the RTB network ecosystem being configured to provide for both the selection and display of the selected creative in real-time.

In one embodiment, a system is provided for a creative within a third-party content slot without navigating a user away from a third-party content document in which the creative was provided for a consumption of a media item associated with the creative. The system includes processing circuitry 50 configured to, as a result of at least a request for a user device 42 to display the third-party content document, provide the creative to the user device 42, the creative being displayable within the third-party content slot, and the creative including a first interface, the first interface associated with an actionable object. The processing circuitry 50 may be further configured to, as a result of at least a user action taken on the actionable object to consume the media item associated with the creative, provide a second interface to the user device 42 for consuming the media item without navigating the user away from the third-party content document by communicating a request to at least one content delivery server 44 to send the media item to the user device 42 to consume the media item at the third-party content document. The system may further include at least one database 24 in communication with the processing circuitry 50 and at least one social media platform 18, the at least one database 24 being configured to store a plurality of user profiles, the plurality of user profiles including fan attributes, and receive user data from the at least one social media platform 18, the fan attributes determined based on the user data from the at least one social media platform 18.

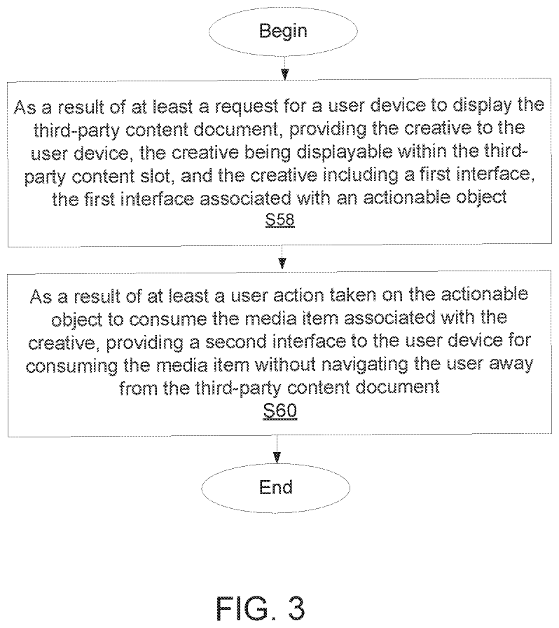

FIG. 3 is a flowchart illustrating an exemplary method implemented in at least one computing device 40, which may in some embodiments be a creative provider 56. The exemplary method is for providing a creative within a third-party content slot without navigating a user away from a third-party content document in which the creative was provided for a consumption of a media item associated with the creative. The method may include, as a result of at least a request for a user device 42 to display the third-party content document, providing the creative to the user device 42, the creative being displayable within the third-party content slot, and the creative including a first interface, the first interface associated with an actionable object (block 558). The method may further include, as a result of at least a user action taken on the actionable object to consume the media item associated with the creative, providing a second interface to the user device 42 for consuming the media item without navigating the user away from the third-party content document (block S60). In some embodiments, the method includes providing the second interface to the user device 42 for consuming the media item without navigating the user away from the third-party content document further includes providing the second interface to the user device 42 for consuming the media item within the third-party content slot within which the creative was displayed, without navigating the user away from the third-party content document (such as, for example, framing). In some embodiments, providing the creative to the user device 42 includes at least identifying a life cycle of the media item and providing the creative to the user device 42 by selecting the creative from a set of creatives based at least in part on the identified life cycle of the media item (e.g., responsive to identifying that the user is a superman and the media item is in pre-release, providing a creative offering pre-release access at a premium cost to the user). In some embodiments, providing the creative to the user device 42 includes: receiving social media data associated with the user from a social media platform 18; based on the social media data, determining a predicted degree of interest in content associated with the media item; and selecting at least one offer from a set of available offers for the media item based at least in part on the predicted degree of interest, an indication of the selected at least one offer being displayable in the first interface of the creative.

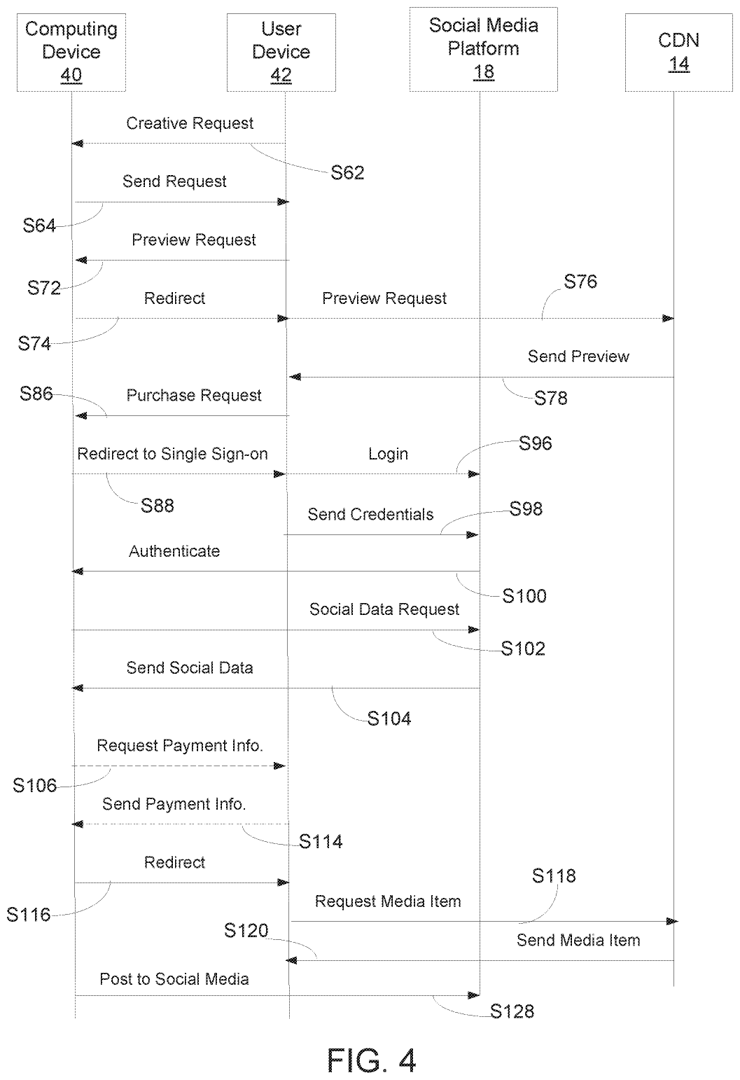

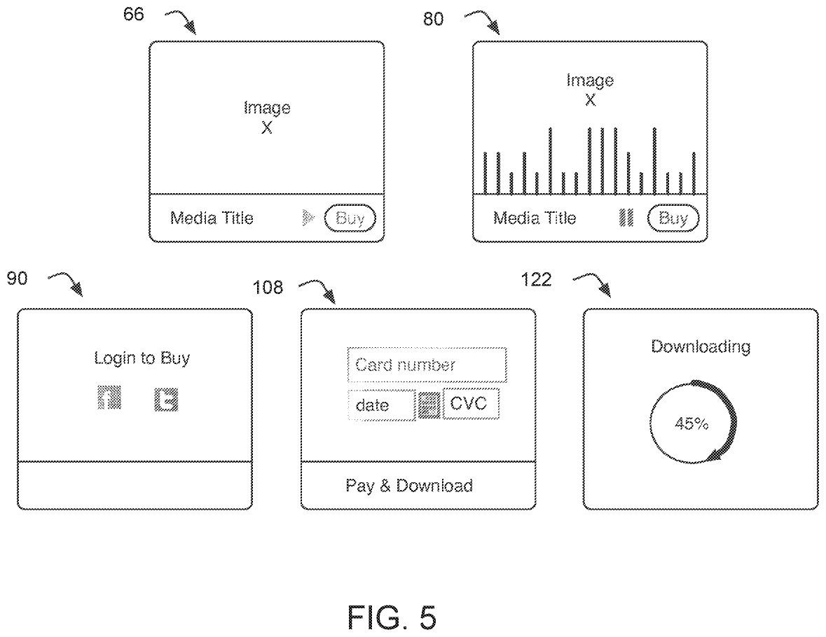

Another example method of providing a creative to a user device 42 will now be described with reference to the flow diagram of FIG. 4, as well as, FIGS. 5-7, which illustrate exemplary user interface flows for providing creatives according to embodiments of the present disclosure.

The user device 42 may request, from the computing device 10, that a creative be displayed (S62) and, as a result, the creative may be sent to the user device 42 (S64). Generally, this occurs when a user experiences a document, such as attempting to visit a website. The user device 42 accesses the website; requests resources from a website server (not shown) (e.g., images, text, etc.); and an application (e.g., browser) displays the website with such resources on a display associated with the user device 42. The code for the website may define third-party content slots (e.g., spaces to be filled with third-party content). In one embodiment, these third-party content slots may be defined at least by HTML code associated with the document. The HTML code may include at least an address (e.g., an Internet Protocol (IP) address) indicating a location of a server for providing a creative for the third-party content slot. The server of the creative is typically different from a server of primary content of the website or document. Stated another way, the third-party content slot may be configured for insertion/delivery of content from at least one server (e.g., an ad server, computing device 40) that is a third-party server with respect to a publishing server of primary content of the third-party content document. The user device 42, by attempting to access the website, may make a call to the server identified by the IP address, which may be, the computing device 40 operating as e.g., an ad server.

The process for the computing device 40 to select which creative to serve the user device 42 and therefore which creative to display within the third-party content slot generally happens fairly quickly, without the user noticing. Such process may involve one or many advertisers bidding on the slot in real-time via, for example, the ad exchange 16 and/or a real-time bidding (RTB) ecosystem. The process may involve determining information about the particular user associated with the user device 42 and allowing advertisers to bid on the right to present their creative to the particular user. In some embodiments, the process for bidding in the RTB can occur within a fraction of a second and the advertiser agrees to pay the ad exchange 16 to distribute the creative to the user device 42 and, in turn, the ad exchange 16 agrees to compensate the owner of the document (e.g., the website owner). Thus, methods for identifying the user and his/her interests, characteristics, and/or attributes within this time period can be extremely helpful to advertisers in determining which users to bid for and how much to bid for the right to present a creative to such user(s). Otherwise, network and processing resources may be wasted presenting a creative to a user that is not a good candidate and not likely to receive the creative well. Users tend to be annoyed by advertisements; thus, it is desirable to present only those creatives that will have a high degree of interest and relevance to the user. According to one embodiment, the computing device 40 may be configured to access the user profile database 24 and/or one or more social media platforms 18 to assist advertisers with determining whether and what creative should be presented to the user.

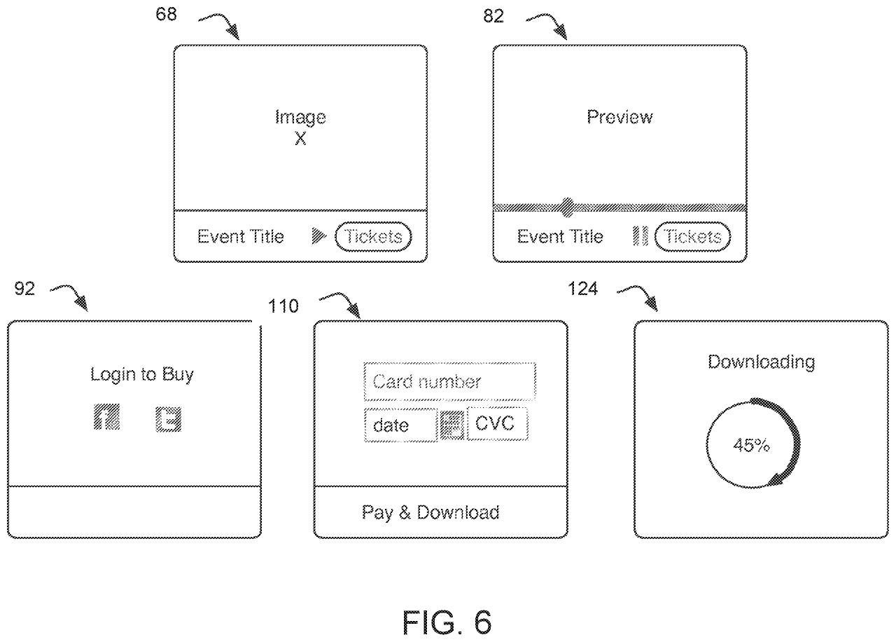

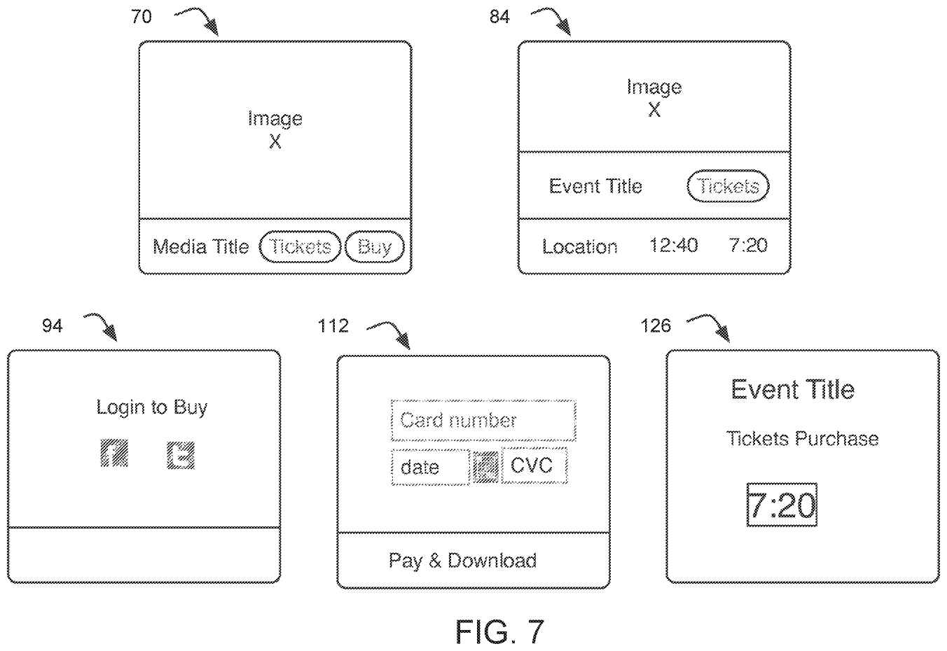

Once the creative is selected and sent to the user device 42, the creative can be displayed to the user within the third-party content slot. FIG. 5 illustrates an example of a creative advertising a song (hereinafter “song creative”) to the user. The song creative may have a first interface 66 advertising the song in a first level of engagement. In one embodiment, the first level of engagement may be to view an image associated with the song. The first interface 66 may invite the user to further engage with the media item at a next level of engagement (e.g., previewing the song and/or purchasing access to the song). FIG. 6 illustrates an example of a creative advertising a movie (hereinafter “movie creative”) to the user. The movie creative may have a first interface 68 advertising the movie in a first level of engagement, such as viewing an image advertising the movie. The first interface 68 may invite the user to further engage with the media item at the next level of engagement (e.g., previewing the movie and/or purchasing access to the movie. FIG. 7 illustrates an example of a creative advertising a concert (hereinafter “concert creative”) to the user. The concert creative may have a first interface 70 advertising the concert in a first level of engagement. The first interface 70 may invite the user to further engage with the media item at a next level of engagement (e.g., purchasing the tickets). As can be seen in FIGS. 5-7, the interfaces 66, 68, 70 have an actionable object (e.g., arrow button and purchase button) where the user can click in order to preview or purchase the media item being advertised by the creative.

The user device 42 may request a preview of the media item being advertised by the presented creative by e.g., clicking on the preview arrow button (S72). In some embodiments, delivery of the media item to the user device may be considered a second interface of the creative corresponding to a second level of engagement. In other embodiments, the second interface may be presented responsive to a purchase of the media item. Responsive to the request to preview, the computing device 40 may redirect the user device 42 to the content delivery network 44 for receiving the preview (S74). Such redirection may be, for example, the computing device 40 sending the user device 42 an IP address identifying a server in the content delivery network 44 that can deliver the preview. The user device 42 may then send a request to the identified server in the content delivery network 44 requesting the preview (S76). The content delivery network 44 may then send the preview to the user device 42 (S78). As a result, the preview may be displayed or otherwise presented to the user via the user device 42. FIG. 5 shows the song preview 80 being played for the user within the creative. As can be seen in FIG. 5, the song preview 80 is presented to the user without the user device 42 being navigated to a different document or website. FIG. 6 illustrates the movie preview 82 being presented to the user within the creative and FIG. 7 illustrates a concert preview 84 being presented to the user within the creative. The concert preview 84 shows additional concert information.

The user device 42 may request a purchase of the media item being advertised by the creative by e.g., clicking on the “buy” button in the creative (S86). In some embodiments, the purchase request may be considered a request to consume the media item. As a result of receiving the purchase request, the computing device 40 may redirect the user device 42 to sign-in to the user's social media account in order to make the purchase through the creative (S88). FIGS. 5, 6, and 7 illustrate an exemplary social media account login to buy screen 90, 92, and 94, respectively. The user device 42 may then access the user's social media account at the social media platform 18 (S96). The user may send his/her social media account login credentials to the social media platform 18 (S98). If the login credentials are correct, the social media platform 18 may send an authenticated message to the computing device 40 to notify the computing device 40 that access to the user's social media account has been obtained (S100). As a result of the authentication, the computing device 40 may send a request for social media data and profile information for the user's account to the social media platform 18 via e.g., an API offered by the social media platform 18 (S102). The social media platform 18 may then send the requested data and profile information to the computing device 40 (S104). In some embodiments, the requested information may fan data from the social media platform 18 that is associated with the media item. Fan data may include data identifying those users that have “liked” or “follow” a title, artist, or other subject of the media item advertised by the creative. A title can include a movie title, a television show or series, an album, a concert tour, a music artist, an actor, etc. Such information can be sent by the social media platform 18 to the computing device 40 (e.g., ad server) through the network. In some embodiments, the data and information from the user's social media account may be stored at a database, such as, the user profile database 24.

In some embodiments, existing user data from the user profile database 24 may also be accessed by the computing device 40 to customize an offer to the user. In one embodiment, all of the collected data on the user can be used to determine a fan ranking for the user for the content attribute (e.g., title, artist, genre, previous purchases by the user, etc.) associated with the media item. In one embodiment, the fan ranking of the media item may be based on at least whether the user likes or follows an artist associated with the media item or a social media page for the media item. By determining a level of fan that the user is for the media item, a more targeted offer can be provided to the user. In one embodiment, a set of predetermined offers may be available at the computing device 40 for the media item and the user data may determine which one of the set of offers is presented to the user. In some embodiments, such determination may be considered a predicted degree of interest in the content associated with the media item. For example, if the computing device 40 determines that the user follows the artist associated with the advertised song but the last time the user interacted with any posts on the artist's social media page was several years ago, the computing device 40 may determine that the user is a low level fan. On the other hand, if the user follows the artist's social media page, has directly visited the artist's website on several instances within the last month, and is following a movie that the artist stars in then the computing device 40 may categorize the user as a superman and provide an offer at a premium. Such fan determinations may be stored in the user profile database 24 and may be accessed by the computing device 40 for future offerings. In one embodiment, the computing device 40 also obtains the life cycle of the media item and uses such information to select the offer. In one embodiment, an indication of the selected one of the predetermined offers may be displayed to the user on the user device 42 within the creative. In some embodiments, the offer may be dynamically selected and displayed to the user on-the-fly based on the data from the social media platform 18 in S102. In other embodiments, a social media account login may not be required. In such embodiments, other methods may be used to select a user-targeted offer, such as, for example, by resolving/matching the user to an existing user profile at the user profile database 24 and using the information stored in the database 24 to select an offer for the user.

The user may accept the displayed offer. The computing device 40 may then send to the user device 42 a request for payment information S106. FIGS. 5, 6 and 7 illustrate exemplary payment information screens 108, 110 and 112, respectively. The user device 42 may then send payment information to the computing device 40 (S114) by e.g., inputting payment information into the payment fields. Responsive to receiving the payment information, the computing device 40 may redirect the user device 42 to the content delivery network 44 to receive the media item to be consumed (S116). In other embodiments, payment is not required in order to consume the media item. Redirection may be performed by sending the user device 42 a message including at least an IP address of a content server within the content delivery network 44 for the media item. The user device 42 may then request the media item from the content delivery network 44 (S118). The content delivery network 44 may then delivery the media item (S120). FIGS. 5-7 illustrate example media delivery screens 122, 124, and 126, respectively. In one embodiment, the media item may be delivered by being downloaded to the user device 42 from the content delivery network 44. In other embodiments, the media item may be streamed to the user device 42. In yet other embodiments, the media item may be delivered in other ways. In one embodiment, delivery of the media item may be performed without navigating the user away from the document/website. In some embodiments, the media item may be provided through an interface (e.g., a second interface) of the creative. The media item may be experienced (viewed and/or listened to) in the same view as the creative. In some embodiments, the media item may be experienced in a dedicated media playing application. In one embodiment, the computing device 40 may post, on behalf of the user, the purchase of the media item on the user's social media account by sending a message to the social media platform 18 (S128). With reference to this example call flow diagram shown in FIG. 4, embodiments of providing, to a user, a creative with a first interface corresponding to a first level of engagement and a second interface corresponding to a second level of engagement have been described.

In some embodiments, data collected from users' social media accounts, as well as, data collected from the user experience applications 20 may be stored in the user profile database 24 to build user profiles and associate those profiles with unique users. The computing device 40 may be an ad server configured to utilize this data to identify a target list for one or more creatives pertaining to a media item. In some embodiments, the computing device 40 may be configured to translate a social media identifier from e.g., the social media platform 18, into an identifier known to and/or accessible to the computing device 40 via, for example, accessing the user profile database 24. In some embodiments, such translation/determination may be performed deterministically or probabilistically. In the deterministic embodiment, the computing device 40 may resolve the social media identifier into a master identifier associated with the user profile database 24, because often the user's social media identifier is stored in the user profile database 24. In a probabilistic embodiment, data from the social media platform 18 can be compared with the data in the user profile database 24. The computing device 40 may then be able to identify user profiles that most likely correspond to the same user as identified by the social media data.

In this manner, the social media platform 18 data can be combined with data known to the computing device 40 via a database, such as, the user profile database 24, to identify a high value user to target for a given campaign. In other words, based on an analysis of user profile data, a creative can be modified or selected in order to maximize both the value of the user to the advertiser and to maximize a likelihood of the user engaging with a creative and/or consuming a media item provided through the creative. The analysis of the user profile data can infer or reveal a user's interests, which can inform how likely a user or fan is to purchase the media item at a particular price point and at a given time period in the product's life cycle. Analyzed data may include one or more of: content consumed previously, information about prior purchases, information about the user's demographic profile (e.g., income, gender, ethnicity, nationality, etc.), etc. Such analysis may yield an expected/predicted likelihood to purchase a media item and an expected/predicted degree of interest in the content or subject of the media item. If, for example, the analysis leads to a conclusion that the user is likely a superman of the media content advertised in the creative, such information can be used to offer the item at a substantial premium. Such premiums may be tied to a product's life cycle, as well. Media items are subject to a life cycle that restricts forms of access to these media items at different times. At earlier times in a product's life cycle, especially periods in which the media has limited availability through traditional channels, the creative can charge a premium for earlier access and some embodiments of the present disclosure do so selectively based on user profile information from a database of pre-stored information (e.g., database 24) and/or data provided on-the-fly from a social media platform 18.

In some embodiments, a product's life cycle can be tied to a pricing profile so that at a first time period when the media item may be less available (e.g., a beginning of a product's life cycle) a pricing range can be set substantially above pricing conventionally offered to regular (e.g., non-super fan) users later in the media item's life cycle. Similarly, at a second time period where the media item is more available, less of a premium (or even a discount) can be offered for access to the media item. In some embodiments, an advertiser can configure via e.g., DSP 14, a pricing profile when setting up a campaign for the creative. In some embodiments, an advertiser can set up via e.g., DSP 14, a split test to offer some users a different price than other users in order to collect data on pricing later in the media item's life cycle.

In some embodiments, the pricing associated with a creative can take into account a pricing profile associated with the creative and a user profile (e.g., in the user profile database 24) to result in a customized price/offer for the media item, tailored to a particular user and a particular life cycle time period in the life cycle of the media item. Such dynamic pricing may permit the computing device 40 to determine a price for a devoted fan that is willing to pay a premium price relative to the market mean. In some embodiments, the creative is only selected for a limited number of users. In some embodiments, only devoted fan are offered the opportunity to purchase the media item through the creative.

Accordingly, some embodiments have been described for providing a multi-level/multi-interface creative in which a first interface is associated with an actionable object, and a second interface is for consuming the media item without navigating the user away from the document that the user is currently at. Further, some embodiments have been described for using social media and other user data in combination with a life cycle of a media item to select a customized creative to be delivered to a targeted user.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A computing device for providing a creative within a third-party content slot without navigating a user away from a third-party content document in which the creative was provided for consumption of a media item associated with the creative, the computing device comprising processing circuitry configured to:
as a result of at least a request for a user device to display the third-party content document, provide the creative to the user device, the creative being displayable within the third-party content slot, and the creative including a first interface, the first interface associated with an actionable object;
as a result of at least a user action taken on the actionable object to consume the media item associated with the creative, provide a second interface to the user device for consuming the media item without navigating the user away from the third-party content document by, communicating a request to at least one content delivery server to send the media item to the user device to consume the media item at the third-party content document;
identify a life cycle of the media item and provide the creative to the user device by selecting the creative from a set of creatives based at least in part on the identified life cycle of the media item;
receive social media data associated with the user from a social media platform;
based on the social media data, determine a predicted degree of interest in content associated with the media item;
select at least one offer from a set of available offers for the media item based at least in part on the predicted degree of interest, an indication of the selected at least one offer being displayable in the first interface of the creative; and
select the creative for insertion with the third-party content slot via a real-time bidding (RTB) network ecosystem, the RTB network ecosystem being configured to provide for both the selection and display of the selected creative in real-time.

2. (canceled)

3. The computing device according to claim 2, wherein the processing circuitry is further configured to provide the second interface to the user device for consuming the media item within the third-party content slot within which the creative was displayed, without navigating the user away from the third-party content document.

4. The computing device according to claim 1, wherein the third-party content slot is defined at least by a Hypertext Markup Language (HTML) code associated with the third-party content document, the HTML code including at least an address indicating a location of at least one computing device for providing the creative for the third-party content slot, and the at least one computing device is different from a server of primary content of the third-party content document.

5. (canceled)

6. (canceled)

7. The computing device according to claim 1, wherein the processing circuitry is configured to provide the creative to the user device by being further configured to
obtain a fan attribute associated with the user from a user profile database, the fan attribute including at least a fan ranking of the user for a content attribute associated with the media item; and
select at least one offer from a set of available offers for the media item based at least in part on the fan ranking of the user for the content attribute of the media item.

8. The computing device according to claim 7, wherein the processing circuitry is configured to provide the creative to the user device by being further configured to:
determine the fan ranking of the user for the content attribute of the media item by at least identifying whether the user at least one of likes or follows at least one of an artist associated with the media item or a social media page for the media item.

9. The computing device according to claim 1, wherein the first interface is configured for the first level of user engagement corresponding to at least one offer for consumption of the media item and the second interface is configured for a second level of user engagement corresponding to the consumption of the media item as a result of an acceptance of the at least one offer for consumption.

10. The computing device according to claim 1, wherein the computing device includes at least one server in communication with at least a social media platform and at least one content delivery server for providing the creative to the user device over a network, the creative associated with the media item from the at least one content delivery server and the creative selected from a set of creatives available for the media item based at least in part on user information from the social media platform.

11. The computing device according to claim 1, wherein the actionable object is a link to the second interface.

12. The computing device according to claim 1, wherein the third-party content slot is configured for insertion of content from at least one server that is a third-party server with respect to a publishing server of the primary content of the third-party content document.

13. The computing device according to claim 1, wherein the third-party content document is a web page displayable by a web browser of the user device.

14. The computing device according to claim 1, wherein the processing circuitry is configured to provide the second interface to the user device for consuming the media item without navigating the user away from the third-party content document by being further configured to redirect the user device to at least one content delivery server for delivery of the media item without navigating the user away from the third-party content document.

15. (canceled)

16. A method for providing a creative within a third-party content slot without navigating a user away from a third-party content document in which the creative was provided for consumption of a media item associated with the creative, the method comprising:
as a result of at least a request for a user device to display the third-party content document, providing the creative to the user device, the creative being displayable within the third-party content slot, and the creative including a first interface, the first interface associated with an actionable object;
as a result of at least a user action taken on the actionable object to consume the media item associated with the creative, providing a second interface to the user device for consuming the media item without navigating the user away from the third-party content document by communicating a request to at least one content delivery, server to send the media item to the user device to consume the media item at the third-party content document;
identifying a life cycle of the media item and providing the creative to the user device by selecting the creative from a set of creatives based at least in part on the identified life cycle of the media item;
receiving social media data associated with the user from a social media platform;
based on the social media data, determining a predicted degree of interest in content associated with the media item; and
selecting at least one offer from a set of available offers for the media item based at least in part on the predicted degree of interest, an indication of the selected at least one offer being displayable in the first interface of the creative.

17. The method according to claim 16, wherein providing the second interface to the user device for consuming the media item without navigating the user away from the third-party content document further includes providing the second interface to the user device for consuming the media item within the third-party content slot within which the creative was displayed, without navigating the user away from the third-party content document.

18. (canceled)

19. (canceled)

20. A system for providing a creative within a third-party content slot without navigating a user away from a third-party content document in which the creative was provided for consumption of a media item associated with the creative, the system comprising:
processing circuitry configured to:
as a result of at least a request. for a user device to display the third-party content document, provide the creative to the user device, the creative being displayable within the third-party content slot, and the creative including a first interface, the first interface associated with an actionable object, and
as a result of at least a user action taken on the actionable object to consume the media item associated with the creative, provide a second interface to the user device for consuming the media item without navigating the user away from the third-party content document by communicating a request to at least one content delivery server to send the media item to the user device to consume the media item at the third-party content document;
identify a life cycle of the media item and provide the creative to the user device by selecting the creative from a set of creatives based at least in part on the identified life cycle of the media item;
receive social media data associated with the user from a social media platform;
based on the social media data, determine a predicted degree of interest in content associated with the media item;
select at least one offer from a set of available offers for the media item based at least in part on the predicted degree of interest, an indication of the selected at least one offer being displayable in the first interface of the creative; and
select the creative for insertion with the third-party content slot via a real-time bidding (RTB) network ecosystem, the RTB network ecosystem being configured to provide for both the selection and display of the selected creative in real-time; and
at least one database in communication with the processing circuitry and at least one social media platform, the at least one database being configured to:
store a plurality of user profiles, the plurality of user profiles including fan attributes, and
receive user data from at least one social media platform, the fan attributes determined based on the user data from the at least one social media platform.
